(19) United States
(12) Patent Application Publication
(10) Pub. No.: US 2024/0253159 A1
(43) Pub. Date: Aug. 1, 2024

(54) SYSTEMS AND METHODS TO CONTROL HANDHELD LASER WELDING EQUIPMENT

(71) Applicant: Illinois Tool Works Inc., Glenview, IL (US)

(72) Inventors: Shuang Liu, Appleton, WI (US); Andrew Pfaller, Hilbert, WI (US); Todd E. Holverson, Appleton, WI (US); Steven B. Massey, JR., Appleton, WI (US); Joseph C. Schneider, Greenville, WI (US); Bruce Patrick Albrecht, Neenah, WI (US); William R. Giese, Monee, IL (US)

(21) Appl. No.: 18/427,618

(22) Filed: Jan. 30, 2024

Related U.S. Application Data
(60) Provisional application No. 63/482,553, filed on Jan. 31, 2023.

(51) Int. Cl. B23K 26/21

(52) U.S. Cl. CPC B23K 26/21

(57) ABSTRACT

Systems and methods for laser welding are disclosed. A laser welding system includes a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

### CROSS REFERENCE TO RELATED APPLICATIONS

This application is a Non-Provisional patent application claiming priority to U.S. Provisional Patent Application No. 63/482,553 entitled “Systems And Methods For Laser Welding And Laser Welding Equipment” filed Jan. 31, 2023, which is herein incorporated by reference in its entirety.

### BACKGROUND

Welding is a process that has historically been a cost effective joining method. Welding is, at its core, a way of bonding two pieces of parent material. Laser welding is a welding technique used to join multiple pieces of metal through the use of a laser. The laser beam provides a concentrated heat source, enabling a precise control of the heat input and high welding speed, creating a weld with low heat input, and a small heat affected zone. In various applications, filler metal may be needed for different purposes such as filling a gap between workpieces, reinforcing the joint, overlaying a substrate surface, building up an object, or acting as a buffering medium.

Conventional laser-based welding tools can create challenges for new users, especially for manually operated laser welders. Even welders with long experience with arc-related welding systems may be unfamiliar with the peculiarities of a laser welding system, including how to achieve a quality weld bead and incorporate laser protection features. Thus, systems and/or methods that facilitate and stabilize welding from laser based welding systems with laser protection features is desirable.

### SUMMARY

This disclosure relates generally to laser welding systems, methods, and apparatuses. More particularly, this disclosure relates to manually operated laser welding systems and torches, which may employ a continuously fed electrode wire for use in laser welding processes, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example laser type welding system, in accordance with aspects of this disclosure.

FIG. 2 illustrates another example laser type welding system, in accordance with aspects of this disclosure.

FIG. 3 illustrates yet another example laser type welding system, in accordance with aspects of this disclosure.

The figures are not necessarily to scale. Wherever appropriate, similar or identical reference numerals are used to refer to similar or identical components.

### DETAILED DESCRIPTION

Disclosed example systems and methods for laser welding are provided. In particular, disclosed example laser welding systems include a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

As used herein, the word “exemplary” means serving as an example, instance, or illustration. The examples described herein are not limiting, but rather are exemplary only. It should be understood that the described examples are not necessarily to be construed as preferred or advantageous over other examples. Moreover, the term “examples” does not require that all examples of the disclosure include the discussed feature, advantage, or mode of operation.

As used herein, a wire-fed welding-type system refers to a system capable of performing welding (e.g., gas metal arc welding (GMAW), gas tungsten arc welding (GTAW), etc.), laser beam welding (LBW—the process by which materials are fused together by laser light from a laser source), brazing, cladding, hardfacing, cleaning, ablating, and/or other processes, in which a filler metal (e.g., a hot or cold wire) is provided by a wire that is fed to a work location, such as an arc or weld puddle.

As used herein, the term “welding-type operation” includes a welding operation employing a laser welding systems using laser energy, operable to fuse, bind, clean and ablate, and/or cut one or more materials and/or layers of materials.

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

For the purpose of promoting an understanding of the principles of the claimed technology and presenting its currently understood best mode of operation, reference will be now made to the examples illustrated in the drawings, and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

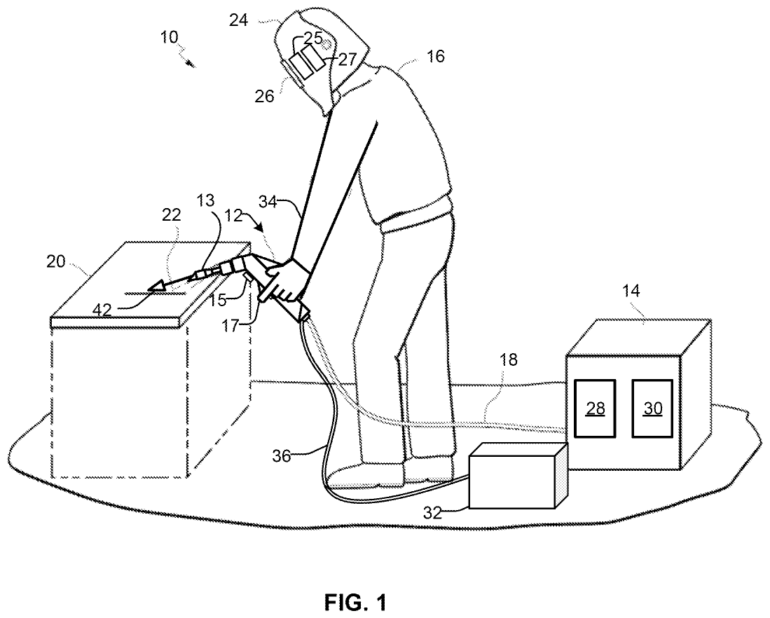

FIG. 1 is a schematic diagram of an example laser welding system 10. The example laser welding system 10 of FIG. 1 includes a laser welding power supply 14, a laser power source 28, a laser controller 30 (e.g., a processing circuitry, control circuitry, memory circuits, interface and/or communication circuitry, etc.), and a wire feeder 32. A handheld laser welding torch 12 is connected to the power supply 14 via power cable 18, and receives wire 36 from the wire feeder 32. In some examples, the handheld laser welding torch 12 includes one or more of a nozzle 13, one or more user input devices 17 (e.g., a trigger, a knob, switch, graphical interface, interlock, etc.), and/or one or more sensors 15 (e.g., an accelerometer, an inertial measurement unit (IMU), a gravimeter, a laser scanner, a wireless transceiver, an ultrasound sensor, a mechanical sensor, temperature sensor, a magnetometer, a gyroscope, an optical sensor, an electrical sensor, etc.).

The laser source 28 generates welding-type laser power to output a laser beam 42 (e.g., directed light energy) based on input power received from the power supply 14. The laser source 28 may be a light emitting a CO₂ laser, Nd: YAG laser, diode-type laser, fiber laser, disk laser or any other type of laser generator. As used herein, welding-type lasing power refers to laser power having wavelength(s) that are suitable for delivering energy to metal for welding, cutting, and/or cladding. Laser cleaning operations (e.g., laser ablation) are also conducted by directing one or more laser beams on the workpiece. For instance, the handheld laser welding torch 12 scans the laser beam across the workpiece to remove unwanted material (e.g., metal particulates, spatter, etc.).

An operator 16 can wear one or more of a wearable 34 (such as a glove, a smartwatch, etc.) and/or a helmet and/or glasses 24 to protect the welder's eyes and skin, for instance. In some examples, the helmet 24 includes a screen 26, which may be configured to automatically dim when exposed to intense light, may be a filter for one or more wavelengths (e.g., ultraviolet, infrared, etc.), and/or may be connected to another part of the system (e.g., controller 30). This allows the screen 26 to present information to the operator 16 to inform the welding process. Helmets and glasses are often used during a welding operation, including set up of the welding station, calibration, and/or to oversee automated (e.g., robotic) welding operations. In a laser welding application, the shaded lens of glasses and helmets may provide a degree of protection from direct laser light and/or light reflected from a workpiece. Protective clothing provides a degree of protection from high intensity beams, spatter, etc.

The torch 12 focuses the laser power as a beam 42 at a joint, seam, surface, or weld 22 on a workpiece 20. The laser power 42 heats the workpiece 20 to generate a puddle during welding operations. The wire feeder 32 feeds the wire 36 (e.g., filler wire, cladding material, metal additive) to the puddle generated by the laser beam 42. The wire 36 melts into the puddle in the weld 22. The wire 36 may be fed from a wire supply, such as a wire reel or wire supply drum, and may be conveyed through a cable or other suitable conduit.

During a welding process, the laser controller 30 controls a focal point of the laser beam to wobble in multiple axes as applied to the workpiece 20. By moving the focal point in multiple directions, the laser can induce one or more beneficial effects in the weld. Examples of such beneficial effects that can be induced in the lateral direction(s) include agitating or stirring of the puddle laterally (including in patterns) to improve filler mixing, creating a heat gradient in the puddle in at least a partially lateral direction to induce movement and improve puddle wetting, and/or controlling the heating and/or cooling rates of the puddle in at least a partially lateral direction by controlling where heat is concentrated. The changing wobble patterns can be configured to adjust power distribution and to change a penetration profile of the laser.

In some examples, movement of the laser beam is controlled such that side-to-side motion is variable, random, and/or has multiple changing directions, angles, and/or lengths. For instance, side-to-side movement of the focal point may promote gap filling, wetting at the toes of a workpiece, penetration profile, etc., and may be set to a high wobble frequency (e.g., greater than 100 wobbles/movements per second). The location, movement, size and/or intensity of the laser beam itself (e.g., spot size, power output) and/or the wobble pattern (e.g., scanning pattern, frequency, etc.) can change the penetration profile and/or weld bead quality. In some non-limiting examples, the focal point and depth for a 3-5 mm spot size may be appropriate for materials at half an inch or thicker, and changes thereof will affect the depth and weld profile, which may be appropriate for different applications.

An additional, possibly independently controlled forward-backward motion at a lower wobble frequency could be used to result in a substantially rippled appearance, similar to a traditional ripple look of tungsten inert gas (TIG) welds, and/or other desirable characteristics.

The laser beam 42 can be controlled in any desired pattern, which may include, but is not limited to, a pattern with one or more straight lines and/or one or more curves. In some embodiments, the desired pattern may include a pause or break in the pattern, such as a time interval in which the focal point does not move. The desired pattern may include a circle, an ellipse, a zigzag, a FIG. 8, a transverse reciprocating line, a crescent, a triangle, a square, a rectangle, a non-linear pattern, an asymmetrical pattern, a pause, or any combination thereof. As may be appreciated, a pattern or a combination of patterns may be used and optimized for particular welds and/or welding positions. The movement of the focal point and the relative movement between the workpiece 20 and the laser torch 12 causes the focal point to trace a superimposed pattern over the workpiece 20. The example pattern may be traced by the laser beam 42 to agitate the puddle.

### Laser Welding Torch Control

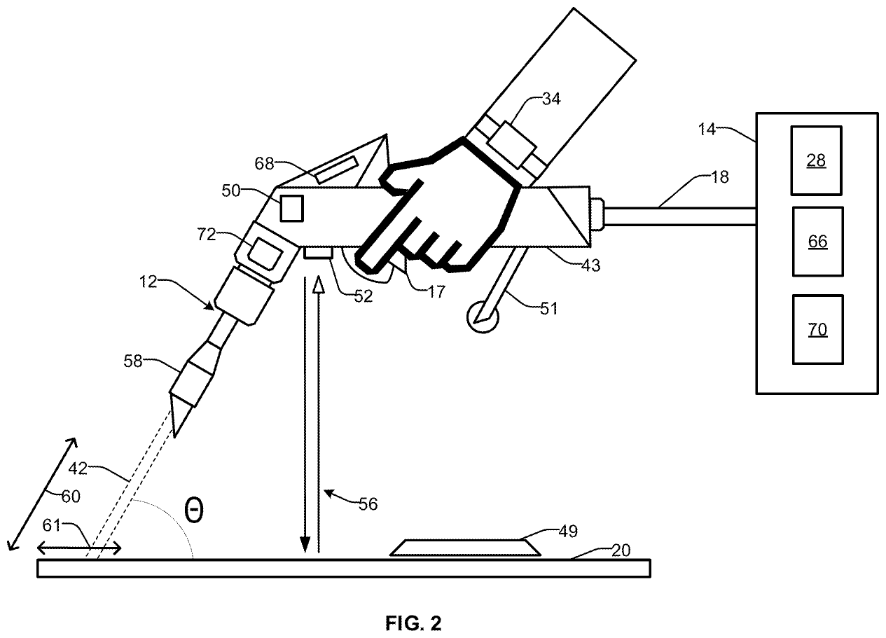

In some disclosed examples illustrated in FIG. 2, the laser welding torch can employ one or more sensors 50, 52 to determine one or more characteristics of the torch 12, and control a function of the welding torch in response. For example, in response to a change in position and/or orientation of the laser welding torch, the welding system 14 can control one or more of the laser power supply and/or the operation of the torch itself, based on the change(s) violating (e.g., rising above or falling below) one or more threshold values.

In examples, the laser welding torch sensors 50, 52 may include one or more of an accelerometer, an inertial measurement unit (IMU), a gravimeter, a laser scanner, a wireless transceiver, an ultrasound sensor, a mechanical sensor, a magnetometer, and/or a gyroscope, as a list of non-limiting examples. Such sensors can measure a position and/or change of position of the torch 12 to determine whether a position and/or orientation the torch 12 exceeds a predetermined value and/or has changed beyond a threshold amount, indicating the torch nozzle 58 has deviated from a welding position or other desirable application. This may indicate an orientation of a downward facing torch has shifted (e.g., by an angle greater than 45 degrees and/or too rapidly) such that the nozzle 58 is oriented away from the joint, weld bead, and/or workpiece 20. Some example sensors can measure a position and/or distance 60 of the torch 12 relative to the workpiece 20 by sending a signal and receiving feedback 56.

Threshold distances and/or angles Θ may correspond to a focal plane or focal point 61 for the laser beam 42. The desired distance or various thresholds may change, depending on application, physical parameters associated with the welding process, and/or a selected welding schedule profile. In examples, a focusing optic or lens 72 (e.g., one or more lenses, galvanometers, mirrors, etc.) can adjust one or more parameters of the laser beam 42 (e.g., location on the workpiece 20, spot size, focal plane, wobble pattern, etc.) in response to sensor and/or user input. In some examples, a list of threshold values are maintained in a memory 70, and/or accessible through a remote database.

In some examples, the handheld laser welding torch 12 includes a user interface 68 (e.g., a knob, switch, trigger, graphical interface, audio input device, etc.), to provide inputs and/or present information and alerts. In examples, instructions can be provided to the laser welding system 14 via a user interface 66, which can also receive inputs from the operator

In response to the sensor input, the laser control system can adjust one or more welding parameters and/or generate one or more alerts. For instance, the system may change (e.g., reduce and/or increase) the laser power output and/or turn off the laser source. In some examples, one or more other components of the welding system may be regulated, including a wire feed speed or a shielding gas flow rate, as a list of non-limiting examples. The system may additionally or alternatively generate an alert or alarm (e.g., audible, visual, haptic, etc.) to inform the operator that the laser welding torch has deviated from a desired position and/or orientation.

In some examples, a calibration technique can be included in a sequence of events to determine and/or set a given position and/or orientation as a “home” position and/or orientation. This can be done via prompting from the system to confirm the position and/or orientation, and/or automatically as the system recognizes the position and/or orientation at the initial trigger pull and/or activation of the laser welding torch or welding operation. The threshold values can correspond to a given welding operation, material type, join type, joint orientation, and/or other welding parameter. In some examples, the operator can set the thresholds prior to activating the welding torch.

In some examples, once the home position and/or orientation has been set, a lock function can be activated such that changes to the calibration and/or home position and/or orientation are prohibited. This ensures that unintentional and/or unauthorized changes to the position and/or orientation and/or thresholds are not accepted (e.g., after a welding operation commences).

In some examples, the system recognizes a particular part and/or welding operation being performed. Thus, the system can generate prompts for the operation of where changes to the position and/or orientation are expected during the welding operation (e.g., length, type, orientation of one or more welds). In some examples, the system automatically adjusts one or more parameters (including the home position and/or orientation) based on the information associated with the part. In some examples, the operator deactivates the laser welding torch and performs one or more of the sequence steps to continue with the welding operation, such as a renewed calibration step.

In some examples, the laser welding torch incorporates or otherwise employs one or more mechanical strain relief devices and/or sensors 45 (e.g., strain gauges, ring gauges, proximity sensors, etc.) to indicate changes in position and/or orientation. For instance, such sensors can be arranged at various interfaces within the torch body and/or cabling, configured to recognize relative changes corresponding to position and/or orientation. Such changes can be compared to a listing of threshold values to determine if the position and/or orientation has deviated from a desired position and/or orientation.

### Torches for Laser Welding Systems

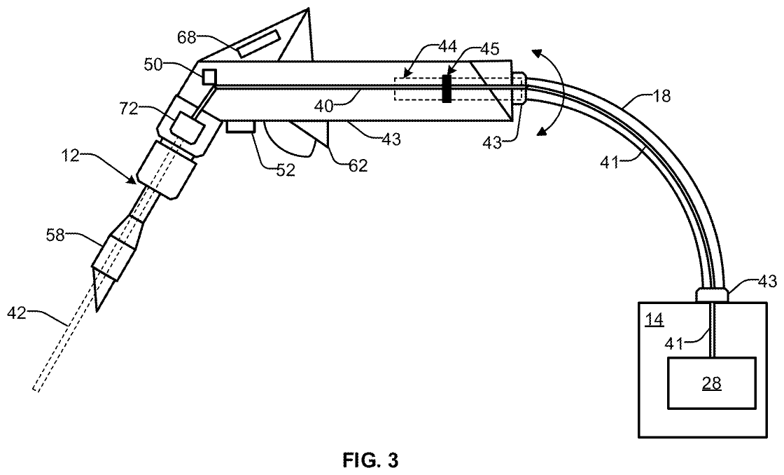

In disclosed examples, systems, methods and/or features are provided for a laser welding torch to ensure desired and long term operation of the torch, as illustrated in FIGS. 2 and 3.

In examples, laser welding torches 12 incorporate one or more torch fiber optic cables 40 to direct laser power from the laser source 28 and/or power supply 14, through one or more optics 72 of the laser welding torch 12, and then output a laser beam 42 onto the workpiece 20. Many torches include a variety of cables 18 and/or components, each of which may connect at an interface or connection point 43, which may be where two structural members meet (e.g., a torch handle and a torch body), and/or where two fiber optic cables meet (e.g., a connector between a power cable and the torch). During a welding operation, such interfaces may bend and/or rotate, causing strain on the fiber optic cables (e.g., both the torch fiber optic cables 40 and cable fiber optic cables 41) and/or fiber optic cable connections.

To avoid impacting serviceability of the fiber optic cables (e.g., causing breaking or misalignment of the various fiber optic cables), in some examples, one or more strain relief devices 45 (e.g., a sensor, a mechanical stop, a rotary encoder, etc.) can be employed to prevent undue strain on the fiber optic cables 40. For instance, the strain relief devices 45 mechanically prevent twisting of the fiber optic cables 40, such that the connections are only physically capable of rotating by a given amount. Example strain relief devices 45 can include complementary rings, which rotate relative to one another in response to movement of the torch, but prevent excess rotation beyond a desired degree (e.g., up to 270 degrees). A bar, cord, or other suitable device can be employed to provide a similar function.

In some examples, the strain relief device 45 is a physical feature at the interface/connection point that prevents winding beyond a threshold amount that may include an feedback response when the winding hits the threshold amount. In other words, the device may make a clicking noise when out of alignment, including clicks, chirps, lights, or a haptic response, as a list of non-limiting examples. An exposed/visible layer of the strain relief device may be included, which deforms, decolors, or otherwise provides a visible indication to the operator of twisting or misalignment.

A sleeve, casing and/or wire 44 can be employed at an interface/connection point to support or channel the fiber optic cables, the sleeve having less flexibility than the fiber optic cables within. This sleeve can prevent over extension during movements associated with welding (at an interface/connection point and/or along the length of the power cable). In some examples, the sleeve 44 extends into and/or through the cable 18.

In some examples, one or more cables collocated within the cable 18 are provided with a stiffness that far exceeds the bending tolerance of the fiber optic cables. For instance, one or more of a power conductor, a tube for channeling welding wire, and/or a conduit for delivering shielding gas can provide stiffness and strength to the cable 18 and/or the connections (at the torch and/or the power supply 14) to ensure the fiber optic cables are not subjected to damaging forces.

In some examples, one or more sensors of the strain relief device 45 are employed by the laser welding torch 12 to monitor movements of the torch and/or relative movement of opposing/connected components of the torch. For instance, a sensor may gauge the rotational movement of the torch relative to the power cable connector 43. The sensor may include one or more of a radial sensor, a strain gauge, a ring gauge, an accelerometer, an IMU, an optical sensor, a magnetic sensor, and/or a heat sensor, as a list of non-limiting examples. The sensor can monitor one or more associated characteristics (e.g., angle of rotation, distance, temperature, strength of the magnetic field, a broken beam, etc.).

If the characteristic value or change in value (e.g., associated with rotation) exceeds a predetermined threshold amount, the sensor can generate a signal to inform the system and/or provide an alert to the operator. The system can use the information to determine if the quality of the weld and/or torch has been impacted, and adjust one or more welding parameters accordingly (e.g., reduce and/or shut off laser power to the torch). Such information relating to the strain on the fiber optic cables can also be used to determine a health of the fiber optic cables, indicating the remaining useful life of the torch and/or power cable.

For instance, the system may recognize heat at connection points as potentially impacting the welding operation in a variety of ways, such as providing less heat/power to the weld. Thus, the system can run a diagnostic check to active welding parameters, the dimensions and/or other characteristics of the weld or weld bead, and alert the operator accordingly.

Regulating the speed of a weld is useful in producing a quality weld. However, the travel speed for laser welding applications can vary from arc welding applications. For instance, laser welding is often associated with intense, narrow spots, which may penetrate deep into the workpiece(s). Therefore, providing information to the operator regarding desired travel speed can enhance weld quality.

A noise (such as an audible beat) can be generated to provide a baseline rhythm for the operator to pace the weld travel speed. The rhythm of this beat can correspond to pulsing of the laser power and/or the wire feed speed.

Additionally or alternatively, a visual indicator can be provided, on a screen, dial or other representation on the welding torch body and/or the helmet (e.g. at screen 26). The visual indicator can be a numerical value (e.g., travel speed in inches per minute, percentage of a desired speed, etc.), graphical (e.g., arrow, stop sign, X, animal image, etc.), or a color (e.g., green, yellow, red), a flashing or pulsing light or sound, as a list of non-limiting examples.

In some examples, one or more sensors (e.g., laser guides, accelerometers, etc.) can measure progress of the welder (e.g., speed), and compare the measured progress to a list of threshold values associated with a particular weld, workpiece and/or welding operation. The comparison can provide an indication of whether the operator is traveling within the desired range of speeds, too slowly or too quickly. If the system determines the speed is outside a desired range, the system can adjust the rhythm of the noise and/or the presented visual indicator to guide the operator to regulate the travel speed.

In some examples, the laser welding torch can be designed as a waterproof gun and/or employ waterproof accessories. Such protections could allow the torch and/or system to be used in less traditional welding applications, such as underwater/sub-surface cleaning, welding, heating, cutting and/or bending operations, as a list of non-limiting examples.

### Accessories and Components for Laser Welding Systems

In some examples, the laser welding torch is configured to receive one or more accessories 47 to facilitate a given welding operation. For instance, a first accessory is attachable to the laser welding torch to generate a first beam width and/or laser pattern corresponding to a first laser welding operation (e.g., a joining operation). A second accessory can also be attached to the laser welding torch to generate a second beam width and/or laser pattern corresponding to a second laser welding operation (e.g., a cutting operation).

In examples, the system is configured to automatically recognize the type of accessory and make adjustments to the welding parameters to support the selected laser welding operation.

In some examples, external accessories can be employed to perform a desired weld. For example, a form 49 can be configured to mate with one or more workpieces and/or the handheld laser welding torch 12 to facilitate a weld. The form can include a channel to guide the torch (e.g., orientation, position, direction, etc.) to perform the weld. The form can also be fixed to and/or support the torch and/or the workpieces. The forms ensure consistency in torch placement and weld outcomes, while making such operations faster for many operators. In some examples, the form 49 can project a light or laser pattern on the workpiece 20 visible to the user. The light pattern can present a path for the user to follow to provide a desired weld.

In some disclosed examples, a mechanical weld guide device 51 can be employed to provide an indication to the operator as to a distance traveled, a direction of the weld (past and upcoming), and/or proximity of the torch to the workpiece, as a list of non-limiting examples. For instance, the mechanical weld guide device could be a physical device in contact with one or both of the workpiece and the torch, such as a ball or wheel, to provide data related to the weld progress. The mechanical weld guide 51 may include one or more sensors capable of transmitting information (e.g., to the laser controller), feedback measurements and data from which can be used to adjust one or more outputs (e.g., power outputs, wobble patterns, wire feed speed, etc.). Such a mechanical weld guide device could be used in addition to or in the alternative to other guiding devices or sensors.

In some examples, the forms 49 and/or mechanical weld guide 51 can be arranged for an initial calibration step, which can ensure proper positioning prior to initiating the welding operation. This can include receipt of a desired position and meeting the position/orientation through the forms 49 and/or mechanical weld guide 51, as well as arranging the torch in a desired position or path and setting the forms 49 and/or mechanical weld guide 51 to reflect/maintain that position. Such forms may be used in training a collaborative robot (e.g., cobot).

In some disclosed examples, a laser welding torch is configured with one or more handles to allow for a variety of holding positions for the operator. For instance, a typical, first handle can be supplemented with a secondary handle, such that two-handed operation of the laser welding torch is possible. The secondary handle can be oriented differently from the first handle (e.g., at a different angle) and/or position, depending on the operator's preferences. In some examples, two handles are arranged as mirror images to one another. The handles may be configured as one or more sticks, one or more wheels, and/or other geometric configurations to suit a particular welding operation or operator.

In some examples, the laser welding torch employs one or more techniques to heat a welding wire prior to introduction to the weld puddle. For example, a heating element (e.g., to provide resistive and/or hotwire wire heating) can be positioned along the travel path of the welding wire (e.g., incorporated within the torch) to increase a temperature of the welding wire (below melting temperature of the wire), such that when the heated wire contacts the workpiece, less additional energy is needed to melt the wire.

For instance, a wire heater can be employed to preheat the wire 36 at a location in a wire feed path (e.g., between the wire feeder 32 and the workpiece 20) that is prior to the wire tip (e.g., the end of the wire proximate the puddle). In this example, the preheating process is referred to as hot wire. The example wire heater can receive power from the power supply 14 and uses resistive heating that passes an electrical current through a portion of the wire 36 to generate heat by the resistance of the wire. The wire tip temperature can be controlled to be constant or adjusted based on welding puddle conditions such as welding puddle dimension and/or temperature, with information captured from a sensor, such as a camera. However, the wire heater may use other methods of heating, such as induction heating, infrared heating, and/or any other wire heating method, such as resistance heating between the contact tip to the workpiece.

In disclosed examples, a handheld laser welding torch includes a nozzle to direct laser power from a laser source to a workpiece to perform a laser welding operation; and a sensor to measure one or more physical parameters of the handheld laser welding torch relative to the workpiece, wherein the sensor is configured to transmit signals corresponding to measurements to a laser control system to regulate one or more outputs of the laser source or a welding accessory.

In some examples, the sensor is configured to calibrate an initial position of the nozzle relative to the workpiece.

In examples, the sensor is configured to access a list of the threshold values corresponding to one or more of a type of welding operation, a material type, a joint type, or a joint orientation, a fit-up of the two or more workpieces (e.g., size and arrangement of the gap, joint, seam, etc.), material thicknesses, weld bead size (e.g., received from user input), a weld bead profile (e.g., input from a laser scanner, illustrating a convex and/or concave profile, weld quality, etc.).

In some examples, the handheld laser welding torch further includes a user interface to indicate a torch parameter of the one or more physical parameters has exceeded or fallen below a threshold value of the list of threshold values.

In examples, the user interface is further configured to receive an input from a user or the laser control system corresponding to the type of welding operation, material type, joint type, or joint orientation.

In examples, the user interface includes one or more of a visual display, an audible alert, or a haptic device.

In examples, the sensor includes one or more of an accelerometer, an inertial measurement unit (IMU), a gravimeter, a laser scanner, a wireless transceiver, an ultrasound sensor, a mechanical sensor, temperature sensor, a magnetometer, or a gyroscope.

In examples, the sensor is configured to activate an interlock at the handheld laser welding torch if rotational alignment between a laser welding cable and the handheld laser welding torch exceeds a threshold value.

In some examples, the handheld laser welding torch further includes a trigger configured to allow a laser power output at the nozzle in response to a user input.

In some examples, the welding accessory is one of a wire feeder, helmet, weldment fixture, hotwire power source, or a shielding gas delivery system.

In some disclosed examples, a handheld laser welding torch includes a nozzle to direct laser power from a laser source to a workpiece to perform a welding operation; a connector to receive a laser welding cable comprising one or more fiber optic cables, the laser welding cable connecting the handheld laser welding torch to a laser power source; and one or more strain relief devices at one or more interfaces between the handheld welding torch and the laser welding cable, the one or more strain relief devices to regulate rotation, angling or extension of the one or more fiber optic cables.

In some examples, other conduits or members within the cable (e.g., the wire liner) are stiffer than the fiber optic cables, to prevent the fiber optic cables from bending or breaking.

In some examples, the handheld laser welding torch further includes one or more torch fiber optic cables, wherein the connector includes an optical coupling at the one or more interfaces and is configured to optically couple the one or more fiber optic cables from the laser welding cable to the one or more torch fiber optic cables.

In examples, the one or more strain relief devices includes a mechanical stop to limit rotation of the connector relative to the handheld welding torch or the laser welding cable.

In examples, the one or more strain relief devices includes a sensor to measure a position of the connector relative to the handheld welding torch or the laser welding cable, and to transmit measurement information to a laser controller to adjust an output of the laser power source based on the measurement information.

In examples, the sensor is one or more of a strain gauge, a ring gauge, an electrical switch, a rotary encoder, or a proximity sensor.

In examples, the sensor is configured to measure changes in position or orientation of the handheld laser welding torch, the connector, the laser welding cable, the one or more torch fiber optic cables or the one or more fiber optic cables.

In some examples, the handheld laser welding torch further includes a sleeve to support and channel the one or more torch fiber optic cables or the one or more fiber optic cables, the sleeve having less flexibility than the one or more torch fiber optic cables or the one or more fiber optic cables within.

In examples, the sleeve is configured to deform or decolor to provide a visible indication of rotation or extension beyond a threshold amount.

In some disclosed examples, a handheld laser welding torch includes a nozzle to direct laser power from a laser source to a workpiece to perform a laser welding operation; and a weld guide to control a position or orientation of the handheld laser welding torch relative to the workpiece, the weld guide configured to provide feedback to the handheld laser welding torch corresponding to changes to the position or the orientation thereof. The weld guide can be of any shape and/or direct welding in any shape, pattern or path (e.g., linear, geometric, circular, etc.).

In some examples, the weld guide has a switch for mechanical feedback to inform adjustments to the wobble parameters or other auxiliary devices.

In some examples, the weld guide is a mechanical device mounted to a body of the handheld laser welding torch and extending from the handheld laser welding torch to contact the workpiece.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A handheld laser welding torch, comprising:
a nozzle to direct laser power from a laser source to a workpiece to perform a laser welding operation; and
a sensor to measure one or more physical parameters of the handheld laser welding torch relative to the workpiece,
wherein the sensor is configured to transmit signals corresponding to measurements to a laser control system to regulate one or more outputs of the laser source or a welding accessory.

2. The handheld laser welding torch of claim 1, wherein the sensor is configured to calibrate an initial position of the nozzle relative to the workpiece.

3. The handheld laser welding torch of claim 2, wherein the sensor is configured to access a list of the threshold values corresponding to one or more of a type of welding operation, a material type, a joint type, or a joint orientation.

4. The handheld laser welding torch of claim 3, further comprising a user interface to indicate a torch parameter of the one or more physical parameters has exceeded or fallen below a threshold value of the list of threshold values.

5. The handheld laser welding torch of claim 4, wherein the user interface is further configured to receive an input from a user or the laser control system corresponding to the type of welding operation, material type, joint type, or joint orientation.

6. The handheld laser welding torch of claim 4, wherein the user interface includes one or more of a visual display, an audible alert, or a haptic device.

7. The handheld laser welding torch of claim 1, wherein the sensor includes one or more of an accelerometer, an inertial measurement unit (IMU), a gravimeter, a laser scanner, a wireless transceiver, an ultrasound sensor, a mechanical sensor, temperature sensor, a magnetometer, or a gyroscope.

8. The handheld laser welding torch of claim 1, wherein the sensor is configured to activate an interlock at the handheld laser welding torch if rotational alignment between a laser welding cable and the handheld laser welding torch exceeds a threshold value.

9. The handheld laser welding torch of claim 1, further comprising a trigger configured to allow a laser power output at the nozzle in response to a user input.

10. The handheld laser welding torch of claim 1, wherein the welding accessory is one of a wire feeder, helmet, weldment fixture, hotwire power source, or a shielding gas delivery system.

11. A handheld laser welding torch, comprising:
a nozzle to direct laser power from a laser source to a workpiece to perform a welding operation;
a connector to receive a laser welding cable comprising one or more fiber optic cables, the laser welding cable connecting the handheld laser welding torch to a laser power source; and
one or more strain relief devices at one or more interfaces between the handheld welding torch and the laser welding cable, the one or more strain relief devices to regulate rotation, angling or extension of the one or more fiber optic cables.

12. The handheld laser welding torch of claim 11, further comprising one or more torch fiber optic cables, wherein the connector includes an optical coupling at the one or more interfaces and is configured to optically couple the one or more fiber optic cables from the laser welding cable to the one or more torch fiber optic cables.

13. The handheld laser welding torch of claim 11, wherein the one or more strain relief devices includes a mechanical stop to limit rotation of the connector relative to the handheld welding torch or the laser welding cable.

14. The handheld laser welding torch of claim 11, wherein the one or more strain relief devices includes a sensor to measure a position of the connector relative to the handheld welding torch or the laser welding cable, and to transmit measurement information to a laser controller to adjust an output of the laser power source based on the measurement information.

15. The handheld laser welding torch of claim 14, wherein the sensor is one or more of a strain gauge, a ring gauge, an electrical switch, a rotary encoder, or a proximity sensor.

16. The handheld laser welding torch of claim 12, wherein the sensor is configured to measure changes in position or orientation of the handheld laser welding torch, the connector, the laser welding cable, the one or more torch fiber optic cables or the one or more fiber optic cables.

17. The handheld laser welding torch of claim 16, further comprising a sleeve to support and channel the one or more torch fiber optic cables or the one or more fiber optic cables, the sleeve having less flexibility than the one or more torch fiber optic cables or the one or more fiber optic cables within.

18. The handheld laser welding torch of claim 17, wherein the sleeve is configured to deform or decolor to provide a visible indication of rotation or extension beyond a threshold amount.

19. A handheld laser welding torch, comprising:
a nozzle to direct laser power from a laser source to a workpiece to perform a laser welding operation; and
a weld guide to control a position or orientation of the handheld laser welding torch relative to the workpiece, the weld guide configured to provide feedback to the handheld laser welding torch corresponding to changes to the position or the orientation thereof.

20. The handheld laser welding torch of claim 19, wherein the weld guide is a mechanical device mounted to a body of the handheld laser welding torch and extending from the handheld laser welding torch to contact the workpiece.
